(19) United States
(12) Patent Application Publication
(10) Pub. No.: US 2008/0040200 A1
(43) Pub. Date: Feb. 14, 2008

(54) SYNTHESIZING RECOMMENDATIONS FROM FINANCIAL DATA

(76) Inventors: Marc Hedlund, Berkerey, CA (US); Jason Knight, Berkerey, CA (US)

Correspondence Address: TECHNOLOGY & INTELLECTUAL PROPERTY;STRATEGIES GROUP PC (dba TIPS GROUP), P. O. BOX 1639, LOS ALTOS, CA, 94023-1639, US

(21) Appl. No.: 11/740,237

(22) Filed: Apr. 25, 2007

Related U.S. Application Data
(60) Provisional application No. 60/745,609, filed on Apr. 25, 2006.

(51) Int. Cl. G06F 17/30; G06Q 90/00

(52) U.S. Cl. 705/10

(57) ABSTRACT

Systems, methods and apparatuses for synthesizing recommendations from financial data are provided. In one embodiment, a method is presented. The method includes receiving financial transaction data from a plurality of users related to a first merchant. Furthermore, the method includes deriving from the financial transaction data of the plurality of users a rating for the first merchant. Moreover, the method includes receiving financial transaction data from a plurality of users related to a second merchant. Also, the method includes deriving from the financial transaction data of the plurality of users a rating for the second merchant. Additionally, the method includes providing the rating for the first merchant and the rating for the second merchant to a community of users including the plurality of users.

### CLAIM OF PRIORITY

This application claims priority to U.S. Provisional Patent Application No. 60/745,609, entitled “SYNTHESIZING RECOMMENDATIONS FROM FINANCIAL DATA” and filed Apr. 25, 2006, which is hereby incorporated herein by reference.

### BACKGROUND

Consumer ratings systems have been in existence since time immemorial. At one time, the guild symbol hanging outside a shop provided evidence of quality of goods, and consumers used that as a rating indicator. Much more recently, organizations have evaluated shops and service providers, resulting in consumer ratings from the Consumer Union organization (in the form of Consumer Reports) and from AAA (formerly the American Automobile Association). Outside the U.S., Michelin guides are well known sources of ratings. All of these sources suffer from limited sampling opportunities—the provider of the report or guide must have someone use the service and then report back. As a result, variations due to unusual circumstances can creep into the system.

Businesses regularly get feedback directly from customers—such as through comment cards at restaurants and hotels. However, these tend to be mainly related to complaints, and also represent a small sample size relative to the number of consumers. More recently still, online ratings services have become more common. For example, one website allows consumers to rate new stories with 1 to 5 stars. Similarly, another website allows consumers to rate books and other items with 1 to 5 stars. Unfortunately, such systems tend to be useful only at the extremes. People who have strong feelings about a product will rate the product, whether good or bad. People who have middling levels of opinion about a product are less likely to choose three stars than to leave the rating blank, presumably for lack of interest.

Search engines can also use ratings of a different sort. One search engine treats every link on a website as a recommendation of the website pointed to by the link. Thus, the number of links to a website provides a numerical value related to the popularity of the website. To make this work, such a search engine typically looks at large portions of the World Wide Web and accumulates information about its connections, resulting in numerical values for the number of connections. However, a search engine is likely to only do slight analysis of the context of links—it likely looks mainly at what words are displayed to signify the link.

For example, a link to the Ghirardelli website with the words “great chocolate” would associate the words “great chocolate” with the Ghirardelli website in such a search system. However, many people may link to a website to indicate it is wrong, and thereby increase the numerical value associated with the website in question—even though the links are the result of disapproval of the website. This allows for potential manipulation of the system. Moreover, the approach described above is enabled by the nature of the World Wide Web and similarly limited, it is not scalable to determinations of who has purchased from an online store, for example.

Thus, each of the various forms of ratings and feedback tend to leave something to be desired. Combining more than one system may provide more information. However, no combination of the systems is likely to remedy the sample size problem inherent in these systems. Accordingly, it may be desirable to obtain a large sample size of indications that a business should be patronized. Additionally, it may be desirable to combine this with another rating system.

### BRIEF DESCRIPTION OF THE DRAWINGS

The present invention is illustrated by way of example in the accompanying drawings. The drawings should be understood as illustrative rather than limiting.

FIG. 1 illustrates financial transactions of several users.

FIG. 2 illustrates aggregated data from financial transactions of FIG. 1.

FIG. 3 illustrates an embodiment of a process of reviewing financial transactions.

FIG. 4 illustrates still another embodiment of a system for obtaining financial data.

FIG. 5 further illustrates the embodiment of FIG. 4, adding dataflow information.

FIG. 6 illustrates an embodiment of a process of handling financial data.

FIG. 7 illustrates an embodiment of a network on which financial data may be transferred.

FIG. 8 illustrates an embodiment of a machine or computer which may be used in the various embodiments of systems.

FIG. 9 illustrates a medium which may be used as part of an implementation of various embodiments.

FIG. 10 illustrates an embodiment of a process of handling cash transactions.

### DETAILED DESCRIPTION

A system, method and apparatus is provided for synthesizing recommendations from financial data. The specific embodiments described in this document represent examples of the present invention, and are illustrative in nature rather than restrictive.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments.

In one embodiment, a method is provided. The method includes receiving financial transaction data from a first user related to a first merchant. The method also includes receiving financial transaction data from a second user related to the first merchant. The method further includes deriving from the financial transaction data of the first user and the financial transaction data of the second user a rating for the first merchant. The method also includes providing the rating for the first merchant to a community of users including the first user and the second user.

In another embodiment, a system is provided. The system includes an aggregation interface to receive financial transaction data related to a plurality of users. The system also includes a data storage interface to store and retrieve the financial transaction data related to the plurality of users. The system further includes an analysis engine to compute ratings of merchants based on the financial transaction data related to the plurality of users.

In yet another embodiment, a method is provided. The method includes receiving financial transaction data from a plurality of users related to a first merchant. Furthermore, the method includes deriving from the financial transaction data of the plurality of users a rating for the first merchant. Moreover, the method includes receiving financial transaction data from a plurality of users related to a second merchant. Also, the method includes deriving from the financial transaction data of the plurality of users a rating for the second merchant. Additionally, the method includes providing the rating for the first merchant and the rating for the second merchant to a community of users including the plurality of users.

In still another embodiment, a method is provided. The method includes receiving financial transaction data from a first user related to a first set of merchants. Also, the method includes receiving financial transaction data from a second user related to a second set merchants. Further, the method includes deriving, from the financial transaction data of the first user and the financial transaction data of the second user, ratings for the merchants of the first set of merchants and the second set of merchants. The method also includes providing the ratings of the merchants of the first set of merchants and the second set of merchants to a community of users including the first user and the second user.

In another embodiment, a system is provided. The system includes means for receiving financial transaction data related to a plurality of users. The system further includes means for storing and retrieving the financial transaction data related to the plurality of users. The system also includes means for computing ratings of merchants based on the financial transaction data related to the plurality of users.

In yet another embodiment, a method is provided. The method includes receiving financial transaction data from a plurality of users related to a set of merchants. The method also includes deriving from the financial transaction data of the plurality of users a rating for each merchant of the set of merchants having associated financial transaction data. The method further includes providing the ratings for the merchants of the set of merchants to a community of users including the plurality of users.

A data aggregation system can use two kinds of recommendations in order to evaluate vendors. First, it can use explicit ratings (e.g. 1 to 5 stars). Second, it can look through the aggregated transaction history of a set of users, and interpret each payment made by a user to a vendor as an implicit endorsement of that vendor. This is similar, in a way, to the system of treating a link like a recommendation; but unlike such a system, this does not aggregate public data on the web. Instead, it aggregates normally private data, and treats that data as a recommendation set even though it was initially simply a transaction. Any user will have some reason to make a purchase from a particular vendor. Whether that reason is convenience, immediate need, or a well considered choice among several vendors, the vendor fulfilled the consumer's need.

One thinks of an economic act as the end result of an evaluation, however well-or poorly-considered it might be in using this approach. If a user decides to buy a camera, the user might go out and look at prices and reputations for many camera shops, and decide on one of those shops as being the “best” by price, reputation, proximity, or some other quality or combination of qualities. If many people in the same area make the same decision the user made, then for some reason they are collectively deciding that this shop is the best. Likewise, if a user goes back to a restaurant every week, the user is, through economic decisions to patronize that restaurant repeatedly, implicitly showing that the user favors that restaurant over other available choices. Similarly, if multiple users regularly patronize a restaurant, this constitutes voting with dollars or other currency, for the restaurant in question.

Where four-or five-star systems tend to miss the day-to-day interactions (the three star ratings), this system captures that. Four-and five-star systems tend to get rants and raves from consumers—providing the ends of the spectrum of experiences. Combining that information with day-to-day patronage data potentially results in a much richer and more complete picture of what businesses provide the best value for consumers. By looking at economic activity of a set of users, one may make much more accurate statements about how people actually decide to spend their money, and about how the set of users may also spend their money. An exclusively explicit system would miss this information.

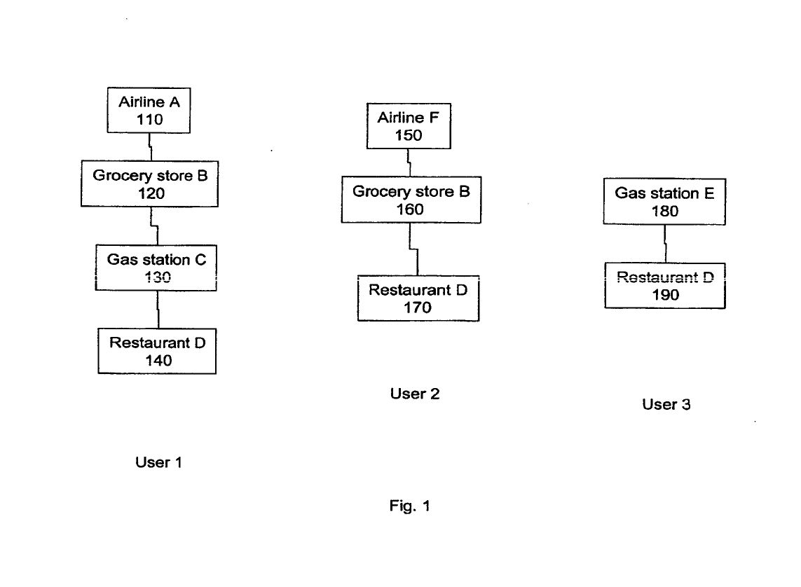

Understanding how user data may be aggregated to provide information about user activity may further illustrate the system. FIG. 1 illustrates a simplified list of recent transactions for several users. User 1 has made purchases from airline A, grocery store B, gas station C and restaurant D. User 2 has made purchases from airline F, grocery store B and restaurant D. User 3 has made purchases from gas station E and restaurant D. From this, a human can infer that grocery store B is potentially popular, and restaurant D is definitely popular. If these transactions also are accompanied by the amount of money involved, this may further illuminate user preferences. For a machine to aggregate this data, it must count the transactions and group transactions with the same vendor, but the same human perceptions can be provided through analysis of this data.

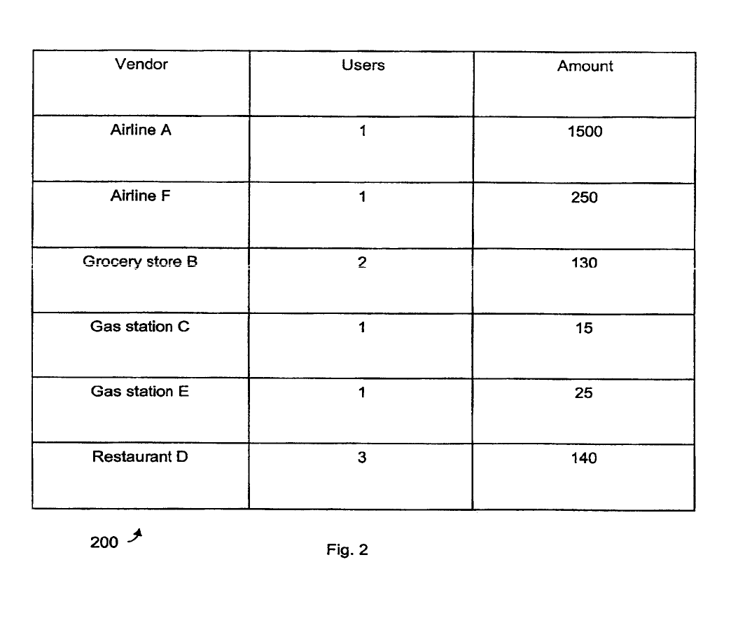

Referring to FIG. 2, table 200 provides an illustration of grouping of the data of FIG. 1. Each vendor is listed, along with entries for the number of users completing transactions with the vendor and the amount of money involved in the total number of transactions. Simply counting the transactions may be enough to provide a ranking of vendors. Moreover, while it is not shown here, a vendor may have multiple transactions with a single user, and that case may be treated either as a single count for the vendor or a count for each transaction. Additionally, the amounts may be used to further enhance the picture of these transactions. Thus, airline A may rank ahead of airline F, due to the discrepancy in dollar amount of the transactions. This may also be used to provide an indication of what type of vendor is being ranked—such that a restaurant that always has transactions of at least $100 may be either very expensive or may cater mainly to large groups. Note that the amounts used in this table were not illustrated in FIG. 1, but they may be included in financial information related to a transaction.

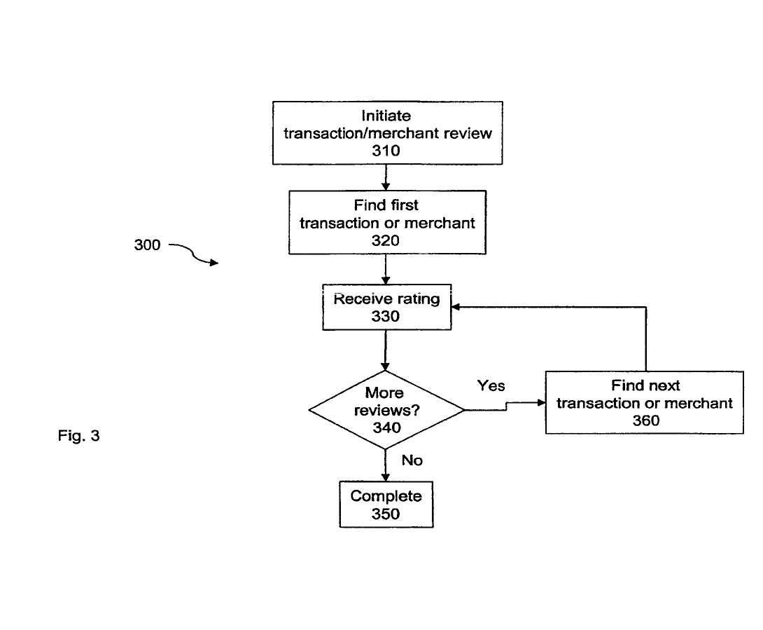

A process for using these transactions within a rating system may be useful as well. Process 300 of FIG. 3 allows for explicit ratings of transactions or merchants. Alternately, it may be implemented in some embodiments to simply verify that transactions occurred, whether a rating is provided or not. The nature of process modules used in process 300 is discussed below.

Process 300 includes initiation of transaction or merchant reviews, finding a first transaction or merchant, receiving a rating for the transaction or merchant, determining if more transactions or merchants exist, finding a next transaction or merchant, and completing the process. Initiation of the review process occurs at module 310, potentially as a result of presentation of a set of transactions, or as a result of an indication by a user that review of transactions is desired. The first transaction or merchant for review is found at module 320. This may be as simple as finding the first transaction for which no review wets previously provided. However, it may involve finding the first transaction of a recent batch of transactions, or finding the first transaction on or after a recent date, or it may involve finding the first unreviewed merchant that makes sense (e.g. skip reviewing the automated teller machine), for example.

With a transaction or merchant found, at module 330, a rating is received from the user. This may be a simple rating (e.g. one or more out of five stars). It may also involve a more sophisticated explanation of the transaction, such as a comment or responses to a set of questions about the transaction or merchant. Moreover, note that this review process may be coupled with a process of interpreting financial information—such as answering questions about the data provided from a financial institution to determine how to interpret that data.

With the rating received, a determination is made as to whether more transactions or merchants still need to be reviewed (or whether the user wants to review more transactions). If so, then at module 360, a next transaction or merchant is found (presumably the next in a data sequence of transactions or list of merchants, but other selection methods may be employed). If no more transactions or merchants are to be reviewed, the process completes, at module 350. This may be as simple as indicating completion to a user, or it may involve more complex operations, such as committing reviews to a database, for example. Additionally, it may allow a user to revisit reviews just entered and revise them, or to provide updated reviews on previously reviewed merchants, for example.

The descriptions and methods discussed and illustrated so far assume an architecture for obtaining private user financial data in an aggregated fashion. Many embodiments of such an architecture may be envisioned. In one embodiment, this is accomplished by providing users a small client program to download from a main web site. The website is a data aggregation website, and the client is a data aggregation client. The data aggregation client resides on the user's machine, and whenever the user is online, the agent downloads the user's bank data from the bank, removes all account and password information from the download, and uploads the transaction history to the data aggregator website.

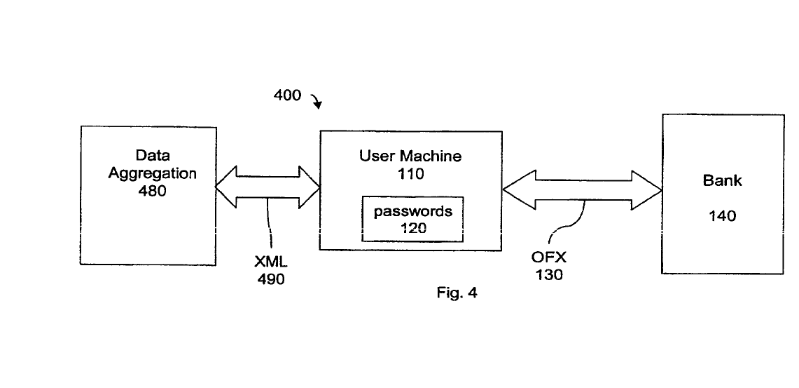

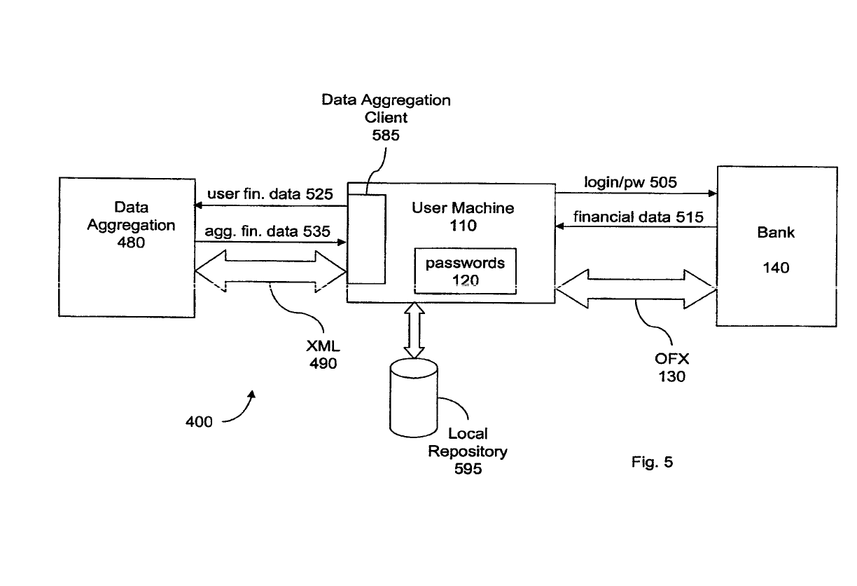

Referring to FIG. 4, a system 400 is provided. User machine 110 maintains user passwords 120 (either by storing them securely or prompting the user for the passwords). User machine 110 communicates with bank 140 using the OFX protocol 130. The user machine 110 also communicates with the data aggregation server/website 480 using XML format 490. The system is further illustrated in FIG. 5. The data aggregation client 585 resides in user machine 110. User machine 110 provides login and password information 505 to bank 140, which, in turn, provides financial data 515. This financial data 515 is then processed and provided by data aggregation client 585 to data aggregation website 480 as user financial data 525. Data aggregation website 480 provides aggregated financial data 535, such as in response to queries or on a periodic basis. Local repository 595 is used to store data such as passwords 120 or financial data for a user.

For Quicken and Money, the point of downloading data is to allow the user to, on their own machine, keep track of their financial accounts—paying bills, balancing their register, and so on. For the data aggregation system, the point of downloading data is to both allow the user to track the data on their own machine and combine it with other peoples' data; thereby to learn more from the aggregate than a user ever could with a single set of data on a single user's machine. Therefore, the purpose of the data aggregation client is to make it easy for a user to combine their data with others' data, without having to sacrifice their privacy or security. For instance, giving the data aggregation website (or other website) their passwords, users risk that a hacker or bad actor employee might take their passwords and use a bank's online bill pay function to write checks out of the user's account. If the user's passwords never leave their own computer (as part of the data aggregation process), no data aggregator employee, nor any attacker who successfully cracked the data aggregator's security systems, would have the ability to attack the user's bank account in this way.

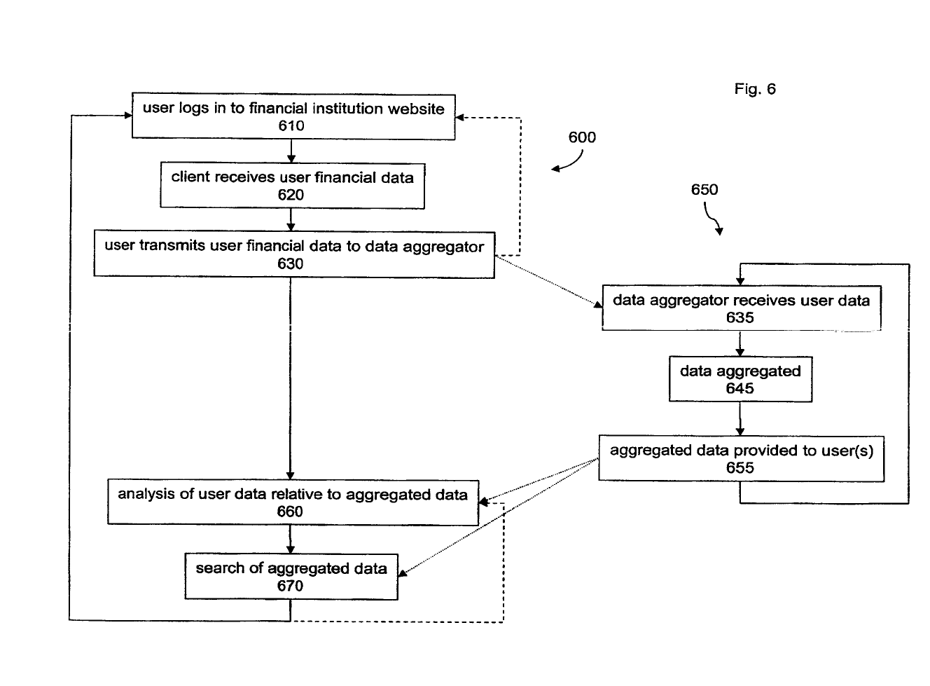

The process for handling the data may be understood with reference to FIG. 6. Process 600 and other processes of this document are implemented as a set of modules, which may be process modules or operations, software modules with associated functions or effects, hardware modules designed to fulfill the process operations, or some combination of the various types of modules, for example. The modules of process 600 and other processes described herein may be rearranged, such as in a parallel or serial fashion, and may be reordered, combined, or subdivided in various embodiments.

Process 600 operates on the user side (e.g. client or user machine) and initiates with user log in to a financial institution at module 610. This may be a user initiated log in operation (e.g. user visits financial institution website) or may be an automatic operation initiated by the data aggregation client in various embodiments. As part of operating with the financial institution website, the client computer receives user financial data from the financial institution at module 620. At module 630, this data is transmitted from the user machine to the data aggregator, using the data aggregation client. Again, this may be affirmatively invoked by the user, or handled automatically on a periodic basis, in various embodiments.

At this point, consideration of process 650 may be illustrative. Process 650 occurs on the server or data aggregator side of the system. At module 635, the data aggregator receives user financial data from the user. This data may be received without identifying information, as it is intended for use in the aggregate. However, the data generally will be received with some form of identifier to allow for personal use separate from use in the aggregate. Such an identifier may be in the form of a personal identifier similar to a bank account number (e.g. typically not derived from anything personally identifiable), for example. The data is aggregated, or entered into some sort of aggregation system at module 645. The aggregated data is provided to the user machine at module 655, such as in response to a query. The process repeats for various user data transfers, from various users.

Thus, the user operating process 600 may receive an analysis of individual user data in relation to aggregated data at module 660. This may provide a sense of how the user's financial picture compares to mean or median financial data for an area, and may be used to provide various other insights. Additionally, at module 670, queries or searches of aggregated data may be initiated, allowing a user to get information about trends among the data aggregator's users in relation to various financial topics.

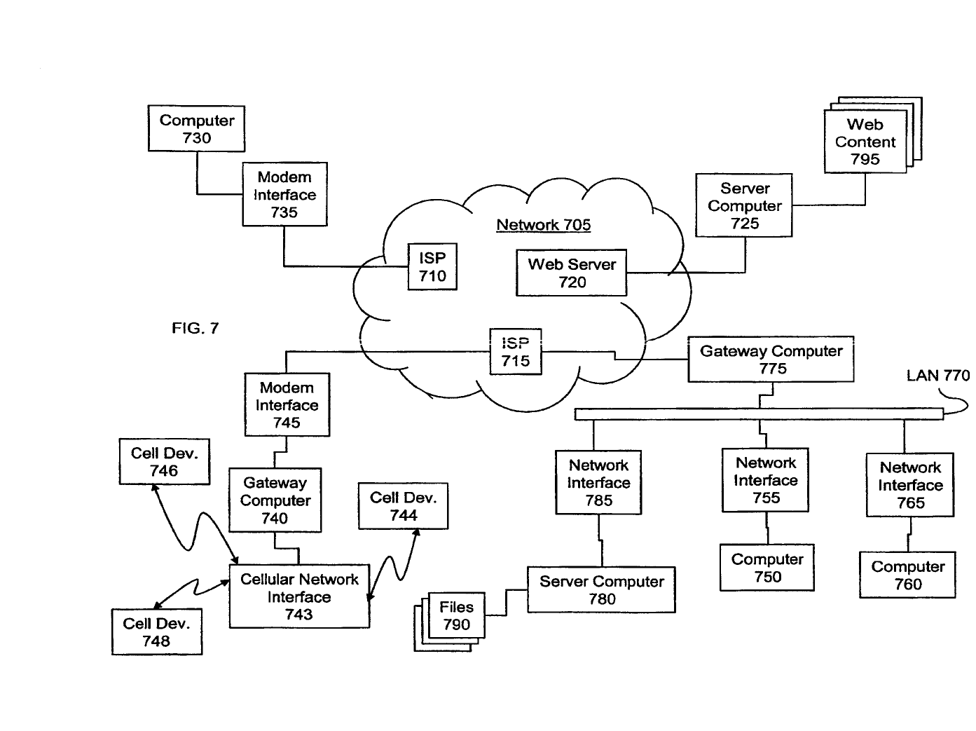

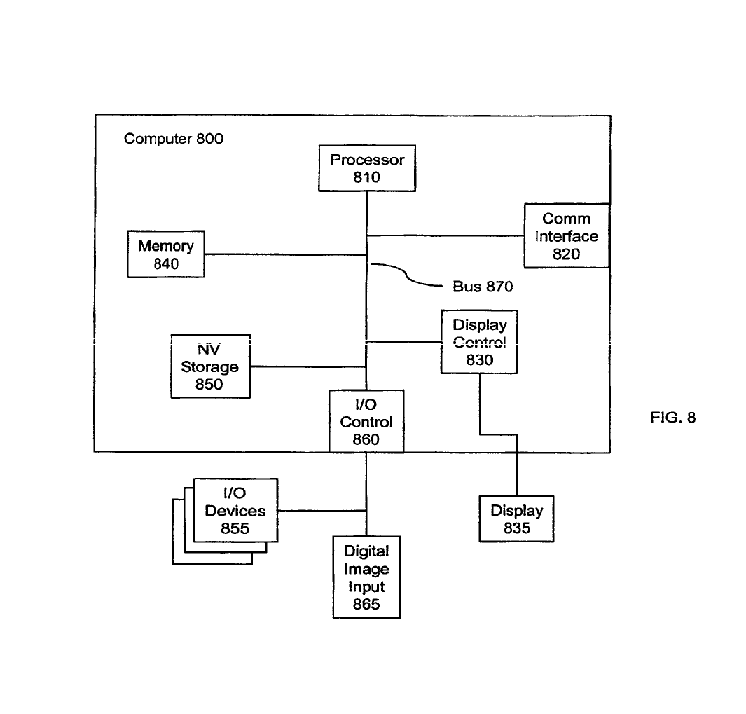

The following description of FIGS. 7-8 is intended to provide an overview of device hardware and other operating components suitable for performing the methods of the invention described above and hereafter, but is not intended to limit the applicable environments. Similarly, the hardware and other operating components may be suitable as part of the apparatuses described above. The invention can be practiced with other system configurations, including personal computers, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 7 shows several computer systems that are coupled together through a network 705, such as the internet, along with a cellular network and related cellular devices. The term “internet” as used herein refers to a network of networks which uses certain protocols, such as the TCP/IP protocol, and possibly other protocols such as the hypertext transfer protocol (HTTP) for hypertext markup language (HTML) documents that make up the world wide web (web). The physical connections of the internet and the protocols and communication procedures of the internet are well known to those of skill in the art.

Access to the internet 705 is typically provided by internet service providers (ISP), such as the ISPs 710 and 715. Users on client systems, such as client computer systems 730, 750, and 760 obtain access to the internet through the internet service providers, such as ISPs 710 and 715. Access to the internet allows users of the client computer systems to exchange information, receive and send e-mails, and view documents, such as documents which have been prepared in the HTML format. These documents are often provided by web servers, such as web server 720 which is considered to be “on” the internet. Often these web servers are provided by the ISPs, such as ISP 710, although a computer system can be set up and connected to the internet without that system also being an ISP.

The web server 720 is typically at least one computer system which operates as a server computer system and is configured to operate with the protocols of the world wide web and is coupled to the internet. Optionally, the web server 720 can be part of an ISP which provides access to the internet for client systems. The web server 720 is shown coupled to the server computer system 725 which itself is coupled to web content 795, which can be considered a form of a media database. While two computer systems 720 and 725 are shown in FIG. 7, the web server system 720 and the server computer system 725 can be one computer system having different software components providing the web server functionality and the server functionality provided by the server computer system 725 which will be described further below.

Cellular network interface 743 provides an interface between a cellular network and corresponding, cellular devices 744, 746 and 748 on one side, and network 705 on the other side. Thus cellular devices 744, 746 and 748, which may be personal devices including cellular telephones, two-way pagers, personal digital assistants or other similar devices, may connect with network 705 and exchange information such as email, content, or HTTP-formatted data, for example. Cellular network interface 743 is coupled to computer 740, which communicates with network 705 through modem interface 745. Computer 740 may be a personal computer, server computer or the like, and serves as a gateway. Thus, computer 740 may be similar to client computers 750 and 760 or to gateway computer 775, for example. Software or content may then be uploaded or downloaded through the connection provided by interface 743, computer 740 and modem 745.

Client computer systems 730, 750, and 760 can each, with the appropriate web browsing software, view HTML pages provided by the web server 720. The ISP 710 provides internet connectivity to the client computer system 730 through the modem interface 735 which can be considered part of the client computer system 730. The client computer system can be a personal computer system, a network computer, a web tv system, or other such computer system.

Similarly, the ISP 715 provides internet connectivity for client systems 750 and 760, although as shown in FIG. 7, the connections are not the same as for more directly connected computer systems. Client computer systems 750 and 760 are part of a LAN coupled through a gateway computer 775. While FIG. 7 shows the interfaces 735 and 745 as generically as a “modem,” each of these interfaces can be an analog modem, isdn modem, cable modem, satellite transmission interface (e.g. “direct PC”), or other interfaces for coupling a computer system to other computer systems.

Client computer systems 750 and 760 are coupled to a LAN 770 through network interfaces 755 and 765, which can be ethernet network or other network interfaces. The LAN 770 is also coupled to a gateway computer system 775 which can provide firewall and other internet related services for the local area network. This gateway computer system 775 is coupled to the ISP 715 to provide internet connectivity to the client computer systems 750 and 760. The gateway computer system 775 can be a conventional server computer system. Also, the web server system 720 can be a conventional server computer system.

Alternatively, a server computer system 780 can be directly coupled to the LAN 770 through a network interface 785 to provide files 790 and other services to the clients 750, 760, without the need to connect to the internet through the gateway system 775.

FIG. 8 shows one example of a personal device that can be used as a cellular telephone (744, 746 or 748) or similar personal device. Such a device can be used to perform many functions depending on implementation, such as telephone communications, two-way pager communications, personal organizing, or similar functions. The system 800 of FIG. 8 may also be used to implement other devices such as a personal computer, network computer, or other similar systems. The computer system 800 interfaces to external systems through the communications interface 820. In a cellular telephone, this interface is typically a radio interface for communication with a cellular network, and may also include some form of cabled interface for use with an immediately available personal computer. In a two-way pager, the communications interface 820 is typically a radio interface for communication with a data transmission network, but may similarly include a cabled or cradled interface as well. In a personal digital assistant, communications interface 820 typically includes a cradled or cabled interface, and may also include some form of radio interface such as a Bluetooth or 802.11 interface, or a cellular radio interface for example.

The computer system 800 includes a processor 810, which can be a conventional microprocessor such as an Intel pentium microprocessor or Motorola power PC microprocessor, a Texas Instruments digital signal processor, or some combination of the two types or processors. Memory 840 is coupled to the processor 810 by a bus 870. Memory 840 can be dynamic random access memory (dram) and can also include static ram (sram), or may include FLASH EEPROM, too. The bus 870 couples the processor 810 to the memory 840, also to non-volatile storage 850, to display controller 830, and to the input/output (I/O) controller 860. Note that the display controller 830 and I/O controller 860 may be integrated together, and the display may also provide input.

The display controller 830 controls in the conventional manner a display on a display device 835 which typically is a liquid crystal display (LCD) or similar flat-panel, small form factor display. The input/output devices 855 can include a keyboard, or stylus and touch-screen, and may sometimes be extended to include disk drives, printers, a scanner, and other input and output devices, including a mouse or other pointing device. The display controller 830 and the I/O controller 860 can be implemented with conventional well known technology. A digital image input device 865 can be a digital camera which is coupled to an I/O controller 860 in order to allow images from the digital camera to be input into the device 800.

The non-volatile storage 850 is often a FLASH memory or read-only memory, or some combination of the two. A magnetic hard disk, an optical disk, or another form of storage for large amounts of data may also be used in some embodiments, though the form factors for such devices typically preclude installation as a permanent component of the device 800. Rather, a mass storage device on another computer is typically used in conjunction with the more limited storage of the device 800. Some of this data is often written, by a direct memory access process, into memory 840 during execution of software in the device 800. One of skill in the art will immediately recognize that the terms “machine-readable medium” or “computer-readable medium” includes any type of storage device that is accessible by the processor 810 and also encompasses a carrier wave that encodes a data signal.

The device 800 is one example of many possible devices which have different architectures. For example, devices based on an Intel microprocessor often have multiple buses, one of which can be an input/output (I/O) bus for the peripherals and one that directly connects the processor 810 and the memory 840 (often referred to as a memory bus). The buses are connected together through bridge components that perform any necessary translation due to differing bus protocols.

In addition, the device 800 is controlled by operating system software which includes a file management system, such as a disk operating system, which is part of the operating system software. One example of an operating system software with its associated file management system software is the family of operating systems known as Windows CE® and Windows® from Microsoft Corporation of Redmond, Wash., and their associated file management systems. Another example of an operating system software with its associated file management system software is the Palm® operating system and its associated file management system. The file management system is typically stored in the non-volatile storage 850 and causes the processor 810 to execute the various acts required by the operating system to input and output data and to store data in memory, including storing files on the non-volatile storage 850. Other operating systems may be provided by makers of devices, and those operating systems typically will have device-specific features which are not part of similar operating systems on similar devices. Similarly, WinCE® or Palm® operating systems may be adapted to specific devices for specific device capabilities.

Device 800 may be integrated onto a single chip or set of chips in some embodiments, and typically is fitted into a small form factor for use as a personal device. Thus, it is not uncommon for a processor, bus, onboard memory, and display/I-O controllers to all be integrated onto a single chip. Alternatively, functions may be split into several chips with point-to-point interconnection, causing the bus to be logically apparent but not physically obvious from inspection of either the actual device or related schematics.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

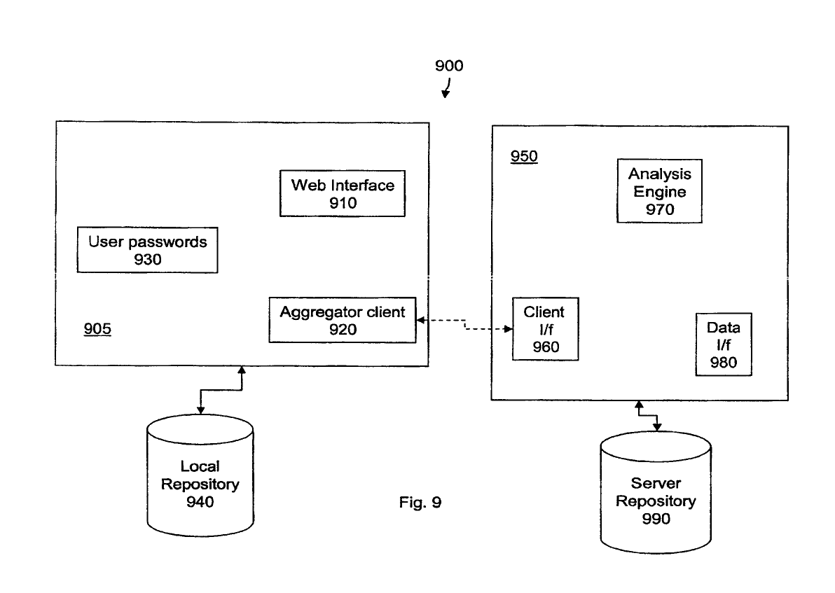

An example of media which may be used in a system is the medium illustrated in FIG. 9. The medium FIG. 9 may be implemented as a single medium, multiple media, or a distributed medium in various embodiments. Medium 905 includes a web interface 910 (such as a web browser, for example), a user password module 930 (which may store user passwords securely, for example), and an aggregator client 920 (which may interface with an aggregator website/server, for example). A local repository 940 may interact with portions of medium 905. Thereby, medium 905 may implement the client-side of a financial data aggregation system in some embodiments.

Medium 950 may implement the server side of a financial data aggregation system in some embodiments. Client interface 960 provides an interface with client-side software such as an aggregator client 920 or similar synchronization or interface software. Analysis engine 970 may implement various functions related to analyzing overall data and determining what patterns exist in such overall data. Data interface 980 may interact with a server repository 990 or similar data storage module to store and retrieve data, for example.

One interesting wrinkle that has not been mentioned previously is worth considering. Restaurant D was selected by all users in FIG. 1. However, if the data from FIG. 1 only included transactions captured by a financial institution, it may be incomplete. If restaurant D was Zachary's Pizza of Oakland and Berkeley, California, its transactions might not show up in such data, as Zachary's only accepts cash payments. Thus, financial institutions such as banks recording debit card transactions, or lenders recording credit card transactions, would not record any Zachary's transactions. Thus, a process for capturing cash transactions may provide additional information.

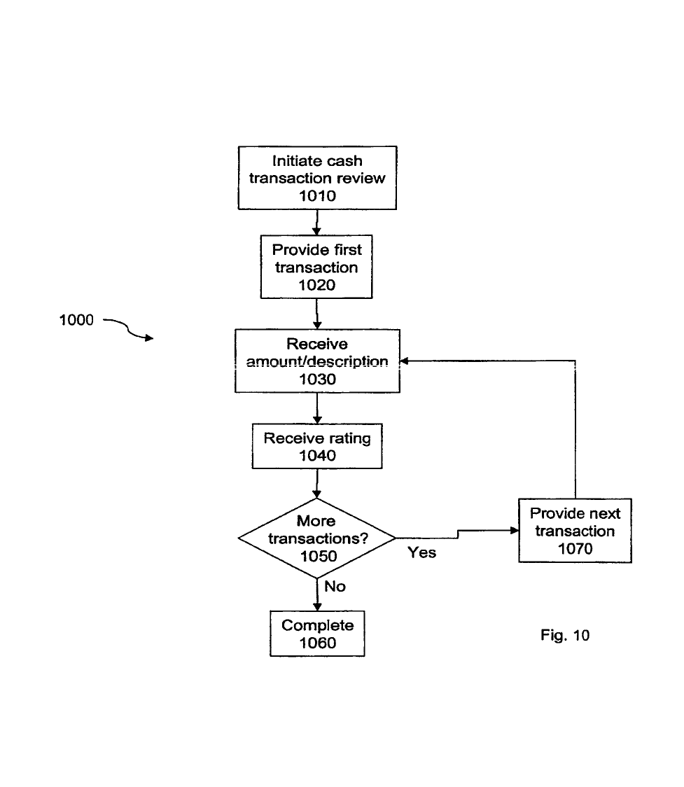

FIG. 10 illustrates an embodiment of a process of reviewing cash transactions. Process 1000 includes initiation of cash transaction reviews, providing a first transaction, receiving an amount and description, receiving a rating, determining if more transactions are available, providing a next transaction, and completing the process. Process 1000 initiates at module 1010, such as through a user indication or selection of an option to review cash transactions, for example. A user may provide a first transaction at module 1020.

For the transaction currently under consideration, at module 1030, the system receives from the user an amount of the transaction and a description of the transaction (e.g. type of vendor, service, etc.) At module 1040, an explicit rating of the transaction is provided (this may be an optional step in the process). At module 1050, the system determines if more cash transactions await review. This may occur as a result of prompting the user on this question, or it may be based on a previously provided number of transactions or an amount of money provided as a total of such transactions.

If more transactions remain for evaluation, the next transaction is provided at module 1070. If no more transactions remain for review, the process completes at module 1060. Completion may be as simple as indicating finished status for a user. However, completion may involve indicating leftover money from a total of transactions not reached in the process will be marked as miscellaneous, for example. Additionally, completion may involve offering a chance to revisit information entered, or to commit data to a database, for example.

This system may be implemented in a variety of different embodiments. However, it is likely to provide the following in most embodiments:
allow users to have their bank security and privacy protected by keeping their bank credentials and passwords on their own computer, never needing to provide those credentials to any third party (such as a data aggregator website or its agents)
obtain recommendations and decision support analyses from the data aggregation service by combining user bank/financial data with other users' data to get aggregate views on vendors, prices, and satisfaction.
   While these features may be expected in most embodiments, other embodiments may implement a system allowing users to securely store bank credentials and passwords with a third party (such as a server maintained by a third-party provider, for example). Similarly, the features and capabilities offered may vary in different embodiments, and there may be a different mix of features from those described above.

One must bear in mind that the embodiments described may be distributed across a variety of machines—the mix of features may relate to whether a particular task is performed at a server or client level, for example, and such a mix may vary from embodiment to embodiment, or within embodiments if some financial institutions allow for one type of access and other financial institutions allow for a different type of access, for example. Similarly, varying user requirements (or permissiveness) may result in such a mix of features. Thus, even these features common to most embodiments are illustrative rather than restrictive of the features of other embodiments.

One skilled in the art will appreciate that although specific examples and embodiments of the system and methods have been described for purposes of illustration, various modifications can be made without deviating from present invention. For example, embodiments of the present invention may be applied to many different types of databases, systems and application programs. Moreover, features of one embodiment may be incorporated into other embodiments, even where those features are not described together in a single embodiment within the present document.

What is claimed is:

1. A method, comprising:
receiving financial transaction data from a first user related to a first merchant;
receiving financial transaction data from a second user related to the first merchant;
deriving from the financial transaction data of the first user and the financial transaction data of the second user a rating for the first merchant;
and
providing the rating for the first merchant to a community of users including the first user and the second user.

2. The method of claim 1, wherein:
the financial transaction data of the first user and the financial transaction data of the second user is devoid of personally identifying information related to the first user and the second user.

3. The method of claim 1, wherein:
the rating is based on a volume of transactions of the first merchant.

4. The method of claim 1, wherein:
the rating is based on proximity of the first merchant to the first user and the second user.

5. The method of claim 1, further comprising:
querying the first user for feedback about a transaction with the first merchant;
and
adjusting the rating of the first merchant responsive to the feedback of the first user.

6. The method of claim 5, further comprising:
querying the second user for feedback about a transaction with the first merchant;
and
adjusting the rating of the first merchant responsive to the feedback of the second user.

7. The method of claim 5, wherein:
the feedback is limited to a response in the group consisting of:
captive, user and fan.

8. The method of claim 5, wherein:
the feedback is limited to a numerical response.

9. The method of claim 1, wherein:
the method is implemented through execution of instructions by a processor, the instructions embodied in a machine-readable medium.

10. A method, comprising:
receiving financial transaction data from a plurality of users related to a first merchant;
deriving from the financial transaction data of the plurality of users a rating for the first merchant;
receiving financial transaction data from a plurality of users related to a second merchant;
deriving from the financial transaction data of the plurality of users a rating for the second merchant;
and
providing the rating for the first merchant and the rating for the second merchant to a community of users including the plurality of users.

11. The method of claim 10, further comprising:
querying a first user of the plurality of users for feedback about a transaction with the first merchant;
and
adjusting the rating of the first merchant responsive to the feedback of the first user.

12. The method of claim 11, further comprising:
querying a second user of the plurality of users for feedback about a transaction with the first merchant;
and
adjusting the rating of the first merchant responsive to the feedback of the second user.

13. The method of claim 12, further comprising:
querying the first user of the plurality of users for feedback about a transaction with the second merchant;
and
adjusting the rating of the second merchant responsive to the feedback of the first user.

14. The method of claim 13, further comprising:
querying the second user of the plurality of users for feedback about a transaction with the second merchant;
and
adjusting the rating of the second merchant responsive to the feedback of the second user.

15. The method of claim 14, further comprising:
providing the rating of the first merchant and the rating of the second merchant to the community of users in a comparative manner

16. The method of claim 11, wherein:
the feedback is limited to a response in the group consisting of:
captive, user and fan.

17. The method of claim 11, wherein:
the feedback is limited to a numerical response.

18. The method of claim 10, wherein:
the financial transaction data of the plurality of users is devoid of personally identifying information related to the users of the plurality of users.

19. The method of claim 10, wherein:
the ratings are based in part on a volume of transactions of the first merchant and of the second merchant.

20. The method of claim 10, wherein:
the ratings are based in part on proximity of the first merchant and the second merchant to the users of the plurality of users.

21. The method of claim 10, wherein:
the method is implemented through execution of instructions by a processor, the instructions embodied in a machine-readable medium.

22. A system, comprising:
an aggregation interface to receive financial transaction data related to a plurality of users;
a data storage interface to store and retrieve the financial transaction data related to the plurality of users;
and
an analysis engine to compute ratings of merchants based on the financial transaction data related to the plurality of users.

23. The system of claim 22, further comprising:
an uploader interface to receive financial transaction data directly from users of the plurality of users, the uploader interface included in the aggregation interface.

24. The system of claim 22, further comprising:
a financial institution interface to receive financial transaction data directly related to users of the plurality of users from financial institutions, the financial institution interface included in the aggregation interface.

25. The system of claim 22, wherein:
the financial transaction data related to users of the plurality of users does not include personally identifying information of the users of the plurality of users.

26. The system of claim 22, wherein:
the financial transaction data related to users of the plurality of users further includes explicit recommendations from the users of the plurality of users.

27. The system of claim 22, wherein:
the financial transaction data related to users of the plurality of users further includes explicit ratings from the users of the plurality of users.

28. The system of claim 23, further comprising:
an uploader client at a client computer chosen by an associated user of the plurality of users, the uploader client to provide financial transaction data from a user of the plurality of users to the uploader interface.

29. The system of claim 28, further comprising:
a user password store located at the client computer chosen by the associated user of the plurality of users.

30. The system of claim 29, further comprising:
a web interface located at the client computer chosen by the associated user of the plurality of users, the web interface to interface with financial institutions and to interface with a community web site at which the ratings of merchants are available.
